(19) United States
(12) Patent Application Publication
(10) Pub. No.: US 2026/0333398 A1
(43) Pub. Date: Oct. 22, 2026

(54) METHOD AND APPARATUS FOR PERFORMING PHYSICAL SIDELINK CONTROL CHANNEL (PSCCH) MONITORING IN SIDELINK COMMUNICATION

(71) Applicant: Intellectual Discovery Co., Ltd., Seoul (KR)

(72) Inventor: Hyuk Min SON, Seoul (KR)

(21) Appl. No.: 19/466,825

(22) Filed: Feb. 2, 2026

Related U.S. Application Data
(63) Continuation of application No. PCT/KR2024/010810, filed on Jul. 25, 2024.

(30) Foreign Application Priority Data
Aug. 4, 2023 (KR) 10-2023-0102104
Jul. 23, 2024 (KR) 10-2024-0096979

(51) Int. Cl. H04W 72/25; H04W 28/02; H04W 72/543; H04W 72/563; H04W 92/18

(52) U.S. Cl. CPC H04W 72/25; H04W 28/0252; H04W 72/543; H04W 72/563; H04W 92/18

(57) ABSTRACT

Sidelink communication methods and apparatus are described. According to one embodiment, a method of a receiving terminal for performing sidelink communication comprises acquiring resource region information for monitoring a plurality of physical sidelink control channels (PSCCHs) and performing monitoring of a specific PSCCH among the plurality of PSCCHs based on the resource region information, wherein the resource region information is configured for transmissions from a plurality of transmitting terminals.

### CROSS-REFERENCE TO RELATED APPLICATIONS

This application is a continuation of PCT Application No. PCT/KR2024/010810, filed on Jul. 25, 2024, which claims priority from Korean Patent Application No. 10-2023-0102104, filed on Aug. 4, 2023, and Korean Patent Application No. 10-2024-0096979, filed on Jul. 23, 2024, which are also incorporated herein by reference in their entirety.

### BACKGROUND OF THE DISCLOSURE

### Technical Field

The present disclosure relates to 3GPP 5G sidelink communication.

### Background Art

As an increasing number of communication devices demand greater communication traffic over time, a next-generation 5G system, which is an enhanced wireless broadband communication system compared to the conventional LTE system, is required. In this next-generation 5G system, also referred to as NewRAT, communication scenarios are classified into Enhanced Mobile Broadband (eMBB), Ultra-Reliability and Low-Latency Communication (URLLC), Massive Machine-Type Communications (mMTC), and so on.

Here, eMBB is a next-generation mobile communication scenario that has characteristics such as High Spectrum Efficiency, High User Experienced Data Rate, and High Peak Data Rate. URLLC is a next-generation mobile communication scenario characterized by features such as Ultra Reliability, Ultra Low Latency, and Ultra High Availability (e.g., V2X, Emergency Service, Remote Control). mMTC is a next-generation mobile communication scenario characterized by features such as Low Cost, Low Energy, Short Packet, and Massive Connectivity (e.g., IoT).

### SUMMARY OF THE DISCLOSURE

The present disclosure is to provide methods and apparatus for performing physical sidelink control channel (PSCCH) monitoring in sidelink communication.

An embodiment of the present specification provides a method in which, in sidelink (SL) communication, a receiving terminal acquires resource region information for monitoring a plurality of physical sidelink control channels (PSCCHs). Thereafter, based on the acquired resource region information, monitoring of a specific PSCCH among the plurality of PSCCHs is performed, wherein the resource region information is configured for transmissions from a plurality of transmitting terminals.

Further, an embodiment of the present specification provides a receiving terminal for sidelink (SL) communication, comprising a control unit, and a memory unit storing instructions and being operably and electrically connectable to the control unit, wherein operations performed based on the instructions being executed by the control unit comprise: acquiring resource region information for monitoring a plurality of physical sidelink control channels (PSCCHs), and, thereafter, based on the acquired resource region information, performing monitoring of a specific PSCCH among the plurality of PSCCHs, wherein the resource region information is configured for transmissions from a plurality of transmitting terminals.

The resource region information is associated with a specific transmission configuration indicator (TCI) state.

The performing of the monitoring of the specific PSCCH among the plurality of PSCCHs is based on a priority.

The priority is indicated via a specific field of the sidelink control information (SCI). For example, the SCI is a first-stage SCI, and the specific field is a priority field.

Furthermore, the priority is based on a PC5 QoS (Quality of Service) identifier (PQI) indicated from a higher layer. Alternatively, the priority is based on a PC5-radio resource control (RRC) signaling or a medium access control-control element (MAC-CE) signaling. Alternatively, the priority is based on a retransmission status of a PSCCH or a physical sidelink shared channel (PSSCH).

At least one of resource regions configured by the plurality of transmitting terminals is reconfigured when an absence of hybrid automatic repeat request (HARQ) feedback from the receiving terminal occurs N times, where N is a natural number greater than or equal to 1.

According to the disclosure of the present specification, PSCCH monitoring for sidelink communication can be efficiently performed in the 3GPP 5G frequency range 2 (FR2) band.

### BRIEF DESCRIPTION OF THE DRAWINGS

FIG. 1 is a diagram illustrating a New Radio (NR) wireless communication system.

FIG. 2 illustrates a structure of a radio frame used in the NR.

FIG. 3 illustrates a slot structure of an NR frame.

FIG. 4 illustrates an example of a Next Generation Radio Access Network (NG-RAN) architecture that supports a PC5 interface.

FIGS. 5A to 5B illustrate procedures for performing sidelink communication according to a sidelink resource allocation mode.

FIG. 6 illustrates an operation method of a terminal according to an embodiment of the present specification.

FIG. 7 illustrates an operation method of a terminal according to another embodiment of the present specification.

FIG. 8 illustrates a wireless communication apparatus according to an embodiment of the present specification.

### DETAILED DESCRIPTION OF THE DISCLOSURE

Although embodiments are described herein using an LTE system, an LTE-A system, and an NR system, these embodiments may be applied to any communication system corresponding to the above definitions.

Furthermore, in the present specification, the term ‘base station’ may be used as a comprehensive term that includes a remote radio head (RRH), an eNB, a transmission point (TP), a reception point (RP), a relay, and the like.

3GPP-based communication standards define downlink physical channels corresponding to resource elements that carry information originating from a higher layer, and downlink physical signals corresponding to resource elements that are used by the physical layer but do not carry information originating from a higher layer. For example, the physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as downlink physical channels, and a reference signal and a synchronization signal are defined as downlink physical signals. A reference signal (RS), also referred to as a pilot, means a predefined special waveform signal known to both a gNB and a UE. For example, cell-specific RS, UE-specific RS (UE-RS), positioning RS (PRS), and channel state information RS (CSI-RS) are defined as downlink reference signals. 3GPP LTE/LTE-A standards define uplink physical channels corresponding to resource elements that carry information originating from a higher layer, and uplink physical signals corresponding to resource elements that are used by the physical layer but do not carry information originating from a higher layer. For example, the physical uplink shared channel (PUSCH), physical uplink control channel (PUCCH), and physical random access channel (PRACH) are defined as uplink physical channels, and a demodulation reference signal (DMRS) for uplink control/data signals and a sounding reference signal (SRS) used for uplink channel measurement are defined.

In this specification, Physical Downlink Control Channel (PDCCH)/Physical Control Format Indicator Channel (PCFICH)/Physical Hybrid automatic retransmit request Indicator Channel (PHICH)/Physical Downlink Shared Channel (PDSCH) respectively mean a set of time-frequency resources or a set of resource elements carrying Downlink Control Information (DCI)/Control Format Indicator (CFI)/downlink ACKnowledgement/Negative ACK (ACK/NACK)/downlink data. Furthermore, Physical Uplink Control Channel (PUCCH)/Physical Uplink Shared Channel (PUSCH)/Physical Random Access Channel (PRACH) respectively mean a set of time-frequency resources or a set of resource elements carrying Uplink Control Information (UCI)/uplink data/random access signals.

Meanwhile, an NR frequency band may be defined with two types of frequency ranges (FR1 and FR2). The numerical values of the frequency ranges may be changed. For example, the two types of frequency ranges (FR1 and FR2) may be as shown in Table 1 below. For convenience of description, among the frequency ranges used in the NR system, FR1 may mean a “sub 6 GHz range”, and FR2 may mean an “above 6 GHz range” and may be called a millimeter wave (mmW).

TABLE 1

| Frequency Range | Corresponding frequency | |
|---|---|---|
| designation | range | Subcarrier Spacing |
| FR1 | 410 MHz - 7125 MHz | 15, 30, 60 kHz |
| FR2 | 24250 MHz - 52600 MHz | 60, 120, 240 kHz |

The numerical values of the frequency range of the NR system may be changed. For example, FR1 may include a band from 410 MHz to 7125 MHz as in Table 1. That is, FR1 may include a frequency band of 6 GHz (or 5850, 5900, 5925 MHz, etc.) or higher. For example, the frequency band of 6 GHz (or 5850, 5900, 5925 MHz, etc.) or higher included in FR1 may include an unlicensed band. The unlicensed band may be used for various purposes, for example, for communication for vehicles (e.g., autonomous driving).

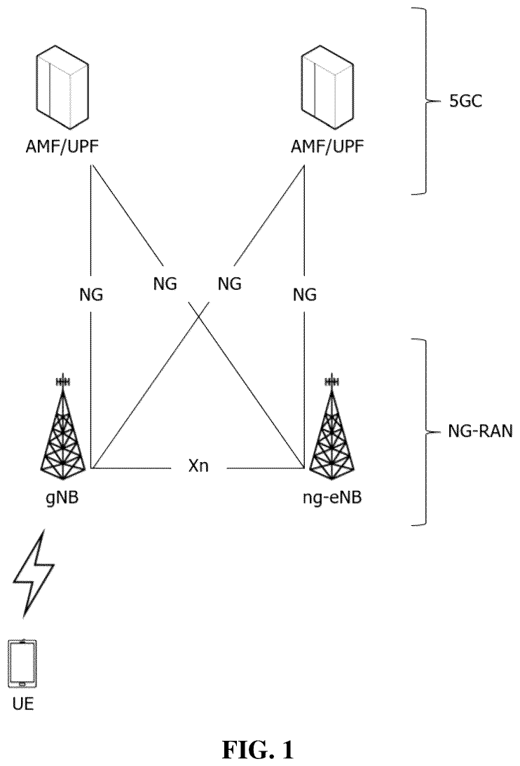

### FIG. 1 is a Diagram Illustrating an NR Wireless Communication System

Referring to FIG. 1, the NR wireless communication system may be classified into a 5G core network (5GC) and a next generation-radio access network (NG-RAN), and the NG-RAN may include base stations (gNB and/or ng-eNB) that provide user plane and control plane protocol termination to a user equipment (UE). A gNB (next generation-Node B) provides NR user plane and control plane protocol termination to the UE, and an ng-eNB (next generation-evolved Node B) provides evolved-universal terrestrial radio access (E-UTRA) user plane and control plane protocol termination to the UE. The user equipment (UE) may be fixed or have mobility, and may be called by other terms such as mobile station (MS), user terminal (UT), subscriber station (SS), mobile terminal (MT), or wireless device. The base station (gNB and/or ng-eNB) may be a fixed station that communicates with the UE, and may be called by other terms such as base transceiver system (BTS), access point, etc.

The base stations (gNB and/or ng-eNB) may be connected to each other via an Xn interface, and may be connected to a 5G core network (5GC) via an NG interface. Specifically, the base stations (gNB and/or ng-eNB) may be connected to an access and mobility management function (AMF) via an NG-C interface, and may be connected to a user plane function (UPF) via an NG-U interface.

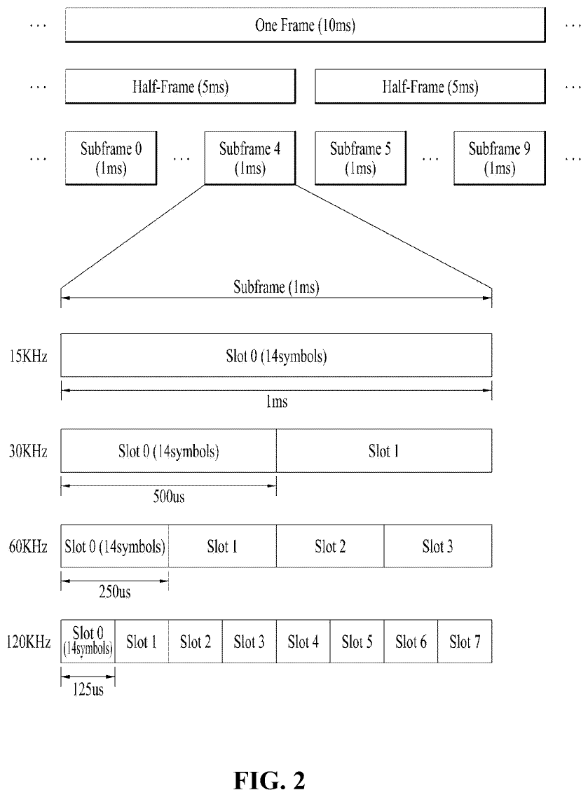

### FIG. 2 Illustrates a Structure of a Radio Frame Used in NR

In NR, uplink and downlink transmissions are composed of frames. A radio frame has a length of 10 ms and is defined by two 5 ms Half-Frames (HFs). A half-frame is defined by five 1 ms subframes (SFs). A subframe is divided into one or more slots, and the number of slots within a subframe depends on the subcarrier spacing (SCS). Each slot includes 12 or 14 OFDM (A) symbols depending on the cyclic prefix (CP). In the case of normal CP, each slot includes 14 symbols. In the case of extended CP, each slot includes 12 symbols. Here, a symbol may include an OFDM symbol (or CP-OFDM symbol) or an SC-FDMA symbol (or DFT-s-OFDM symbol).

Table 2 illustrates that when normal CP is used, the number of symbols per slot, the number of slots per frame, and the number of slots per subframe vary depending on the SCS.

TABLE 2

| SCS(15*2^{u}) | N^{slot}_{symb} | N^{frame,u} ₛₗₒₜ | N^{subframe,u} ₛₗₒₜ |
|---|---|---|---|
| 15 KHz(u = 0) | 14 | 10 | 1 |
| 30 KHz(u = 1) | 14 | 20 | 2 |
| 60 KHz(u = 2) | 14 | 40 | 4 |
| 120 KHz(u = 3) | 14 | 80 | 8 |
| 240 KHz(u = 4) | 14 | 160 | 16 |

N ^{slot} _{symb}: number of symbols in a slot
N ^{frame,u} ₛₗₒₜ: number of slots in a frame
N ^{subframe,u}ₛₗₒₜ: number of slots in a subframe

Table 3 illustrates that when extended CP is used, the number of symbols per slot, the number of slots per frame, and the number of slots per subframe vary depending on the SCS.

TABLE 3

| SCS (15*2^{u}) | N^{slot}_{symb} | N^{frame,μ}ₛₗₒₜ | N^{subframe,μ}ₛₗₒₜ |
|---|---|---|---|
| 60 KHz (u = 2) | 12 | 40 | 4 |

In an NR system, OFDM(A) numerology (e.g., SCS, CP length, etc.) may be set differently among a plurality of cells that are aggregated for a single UE. Accordingly, the (absolute time) duration of a time resource (e.g., SF, slot, or TTI) composed of the same number of symbols (collectively referred to as a Time Unit (TU) for convenience) may be set differently among the aggregated cells.

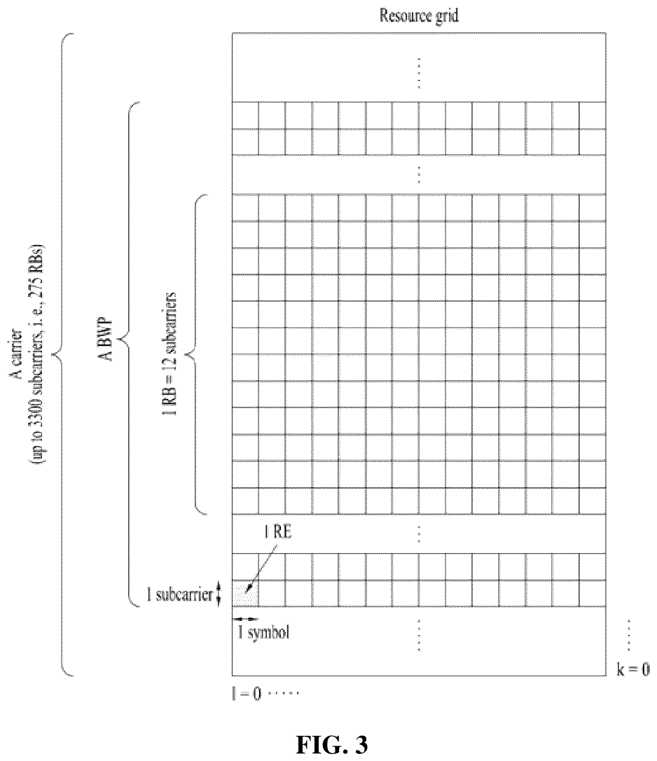

### FIG. 3 Illustrates a Slot Structure of an NR Frame

A slot includes a plurality of symbols in the time domain. For example, in the case of normal CP, one slot includes 14 symbols, but in the case of extended CP, one slot includes 12 symbols. A carrier includes a plurality of subcarriers in the frequency domain. A resource block (RB) is defined by a plurality of (e.g., 12) consecutive subcarriers in the frequency domain. A bandwidth part (BWP) is defined by a plurality of consecutive (P) RBs in the frequency domain, and may correspond to one numerology (e.g., SCS, CP length, etc.). A carrier may include up to N (e.g., 4) BWPs. Data communication is performed through an activated BWP, and only one BWP may be activated for one UE. Each element in a resource grid is referred to as a Resource Element (RE), and one complex symbol may be mapped to it.

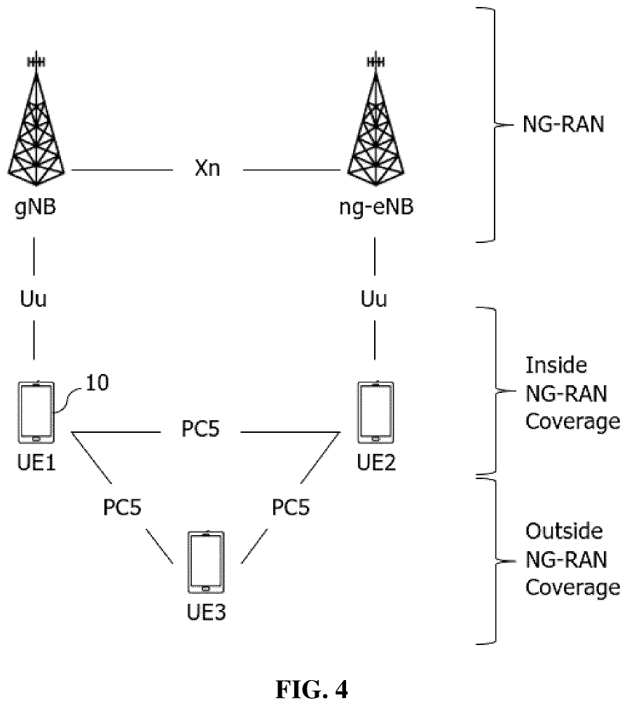

### FIG. 4 Illustrates an Example of an NG-RAN Architecture that Supports a PC5 Interface

Referring to FIG. 4, the next generation-radio access network (NG-RAN) architecture supports the PC5 interface. Sidelink transmission and reception via the PC5 interface are supported both when the user equipment (UE) is inside NG-RAN coverage and when the UE is outside NG-RAN coverage, regardless of the radio resource control (RRC) state of the UE.

Vehicle-to-Everything (V2X) service support via the PC5 interface may be provided by NR sidelink communication and/or V2X sidelink communication. NR sidelink communication may also be used to support services other than V2X services.

NR sidelink communication may support one type among a unicast transmission mode, a groupcast transmission mode, and a broadcast transmission mode. In the case of unicast type sidelink communication, a UE may perform one-to-one communication with another UE. In the case of groupcast type sidelink communication, a UE may perform sidelink communication with one or more UEs within a group to which it belongs.

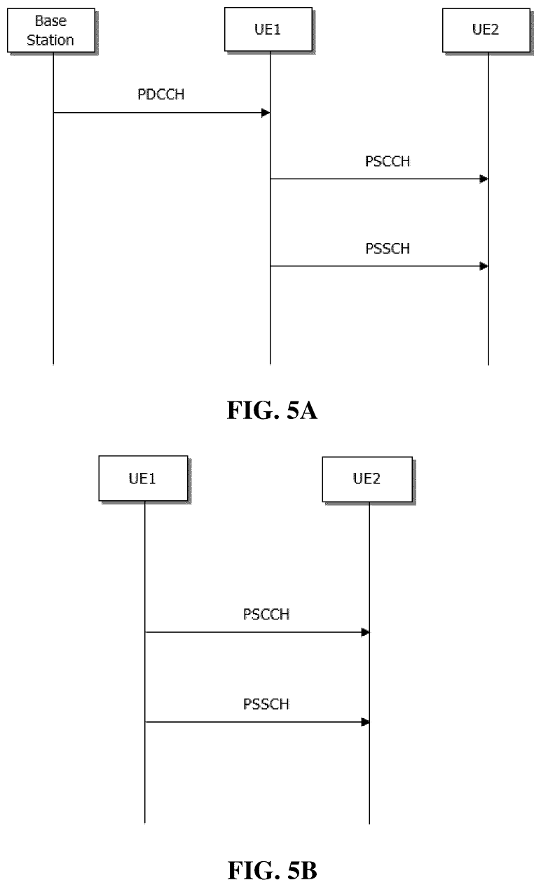

### FIGS. 5A to 5B Illustrate Procedures for Performing Sidelink Communication According to a Sidelink Resource Allocation Mode

FIG. 5A illustrates a UE operation related to NR resource allocation mode 1, and FIG. 5B illustrates a UE operation related to NR resource allocation mode 2.

Referring to FIG. 5A, in NR resource allocation mode 1, a base station may schedule sidelink (SL) resources to be used by a user equipment (UE) for SL transmission. For example, the base station may perform resource scheduling for UE1 using a downlink control channel (DCI) transmitted via a physical downlink control channel (PDCCH), and UE1 may perform V2X or SL communication with UE2 according to the resource scheduling. For example, UE1 may transmit sidelink control information (SCI) to UE2 via the physical sidelink control channel (PSCCH), and then transmit SL data to UE2 via the physical sidelink shared channel (PSSCH) based on the SCI.

Referring to FIG. 5B, in NR resource allocation mode 2, a user equipment (UE) may determine a sidelink (SL) transmission resource within an SL resource configured by a base station or a pre-configured SL resource. For example, the configured SL resource or pre-configured SL resource may be a sidelink resource pool. For example, the UE may autonomously select or schedule a resource for SL transmission. That is, a UE may perform SL communication by autonomously selecting a resource within a configured resource pool. Furthermore, the UE may perform a sensing and resource (re)selection procedure to autonomously select a resource within a selection window. For example, the sensing may be performed on a sub-channel basis. As shown in FIG. 5B, UE1, which has autonomously selected a resource within the resource pool, may transmit SCI to UE2 via the PSCCH, and then transmit data based on the SCI to UE2 via the PSSCH.

In FR2 sidelink (SL) communication, when a single receiving UE performs unicast communication with two or more transmitting UEs, the receiving UE may receive the Physical Sidelink Control Channels (PSCCHs) transmitted by the transmitting UEs with different reception beams (RX beams). If the receiving UE can only perform PSCCH monitoring by applying a single reception beam at each PSCCH monitoring instance, monitoring of a plurality of PSCCHs may not be possible. Therefore, it is necessary to develop an operational method for PSCCH transmission and monitoring to enable efficient PSCCH monitoring. Accordingly, the present specification performs development on the above content and proposes a related solution.

The present specification proposes an operational method for a receiving UE to monitor a PSCCH when performing one or more unicast communications with different UEs via sidelink (SL) in the FR2 band.

In the present specification, for convenience of explanation, a transmitting UE that performs unicast transmission is referred to as a TX-UE (transmission-user equipment), and a UE that receives data from the corresponding TX-UEs is referred to as an RX-UE (reception-user equipment).

In the present specification, for convenience of explanation, a transmission beam used for data/signal transmission is referred to as a TX beam, and a reception beam used for data/signal reception is referred to as an RX beam. In this case, it may be assumed that an RX beam of the RX-UE for PSCCH monitoring for specific TX-UEs has been determined through operations such as unicast establishment, initial beam pairing, and beam maintenance for the TX beam and RX beam used by each transmitting UE and receiving UE.

In the unicast establishment and/or initial beam pairing step or thereafter, each RX-UE may configure and operate a resource region in which a reception attempt may be made with a reception beam configured for PSCCH monitoring.

### First Disclosure: Case of Resource Allocation (RA) Mode 1

In RA mode 1, a base station allocates time/frequency resources to be used for SL communication. Therefore, the base station may configure, for a TX-UE, a resource region in which to attempt reception for PSCCH monitoring via RRC (Radio Resource Control), a Medium Access Control-Control Element (MAC-CE), or DCI (Downlink Control Information) on the Uu interface. Alternatively, it may be configured through a partial or full combination of RRC, MAC-CE, and DCI.

A TX-UE may configure, for an RX-UE, a resource region in which to attempt reception for PSCCH monitoring via a master information block-sidelink (MIB-SL) or a system information block-sidelink (SIB-SL). Alternatively, a TX-UE may configure, for an RX-UE, a resource region in which to attempt reception for PSCCH monitoring via PC5 RRC, MAC-CE, or sidelink control information (SCI). Alternatively, it may be configured through a partial or full combination of PC5 RRC, MAC-CE, and SCI.

Alternatively, a base station may configure, for an RX-UE, a resource region in which to attempt reception for PSCCH monitoring via RRC, MAC-CE, or DCI on the Uu interface. Alternatively, it may be configured through a partial or full combination of RRC, MAC-CE, and DCI.

In the above content, the size of the time resource in the configuration of the resource region for PSCCH monitoring may be indicated in units of a plurality of symbols, a mini-slot, a slot, a frame, etc.

In the above content, the size of the frequency resource in the configuration of the resource region for PSCCH monitoring may be indicated in units of a plurality of sub-carriers, a (physical, P) resource block (RB), a sub-channel, a sub-band, etc.

In the above content, a certain time/frequency region in the configuration of the resource region for PSCCH monitoring may be configured with a period, and in this case, a specific period value may be configured. The RX-UE may perform PSCCH monitoring in a time/frequency region of the same size at each configured period.

The start time of PSCCH monitoring may be indicated through a specific symbol, mini-slot, slot, or frame in signaling that indicates a configuration value for a resource region for PSCCH monitoring (hereinafter referred to as a PSCCH monitoring resource region). Alternatively, a specific time-offset value may be configured, and the start time of the PSCCH monitoring resource region may be after the time-offset value from the reference point of the signaling that indicates the configuration value for the PSCCH monitoring resource region.

Information for PSCCH monitoring configuration may be associated with a specific Transmission Configuration Indicator (TCI) state. That is, when the RX-UE monitors the PSCCH in the PSCCH monitoring resource region, it may use an RX beam that is associated or mapped with the TCI state associated with the corresponding PSCCH monitoring resource region.

### Second Disclosure: Case of Resource Allocation (RA) Mode 2

A TX-UE may determine a resource region not used in other SL communications through resource sensing, and configure a PSCCH monitoring resource region. The configured PSCCH monitoring resource region may be indicated to the RX-UE via PC5 RRC, MAC-CE, or SCI. Alternatively, it may be indicated to the RX-UE through a partial or full combination of PC5 RRC, MAC-CE, and SCI.

In the present specification, for convenience of explanation, when two TX-UEs intend to perform unicast transmission, each TX-UE is referred to as TX-UE #1 and TX-UE #2. And, it is assumed that TX-UE #1 has configured a PSCCH monitoring resource region.

If TX-UE #2 acquires the PSCCH monitoring resource region configuration information of TX-UE #1 in the process of performing resource sensing to configure a PSCCH monitoring resource region, it may configure the PSCCH monitoring resource region in a resource region that does not overlap with the corresponding resource region.

At this time, the configuration information of the PSCCH monitoring resource region of TX-UE #1 may be the entire configuration information, including the entire time/frequency resource location, size, period, time-offset, etc.

Alternatively, it may be part of the configuration information of the PSCCH monitoring resource region.

At this time, being part of the PSCCH monitoring resource region configuration information may mean information about the PSCCH monitoring resource region of TX-UE #1 up to a specific time point after the transmission time of the PSCCH transmitted by TX-UE #1.

Alternatively, being part of the PSCCH monitoring resource region configuration information may mean information that the PSCCH monitoring resource region of TX-UE #1 is configured with a specific period based on the transmission time of the PSCCH transmitted by TX-UE #1.

At this time, in addition to the period, it may include part of the information about the size of the time resource and the location and size of the frequency resource. Alternatively, it may include all or part of the information on the size of the time resource, the size of the frequency resource, and the location of the frequency resource based on the PSCCH transmitted by TX-UE #1 and the corresponding PSSCH. Alternatively, the size of the PSCCH monitoring resource region may be configured and operated to use the same frequency resource location and time/frequency resource size as the transmission resource of the PSCCH transmitted by TX-UE #1 and the corresponding PSSCH. In this case, other TX-UEs may acquire the information on the frequency resource location and time/frequency resource size through decoding of the PSCCH transmitted by TX-UE #1.

### Third Disclosure: Method for Monitoring a Plurality of PSCCHs in an Overlapping Resource Region

For convenience of explanation, the description is based on the assumption that two or more TX-UEs are performing unicast communication with one RX-UE, and the proposed content in this environment can be extended and applied to a situation where there are a plurality of TX-UEs and RX-UEs.

If resource information configured from different TX-UEs overlaps in whole or in part, the RX-UE may determine the priority of PSCCH monitoring and attempt to receive the PSCCH with the RX beam for the corresponding PSCCH monitoring.

The following methods may be applied for the RX-UE to determine the priority of specific PSCCH monitoring.

Method #1: Each SCI may define a field that indicates the priority for PSCCH monitoring. Furthermore, the priority for PSCCH monitoring may be indicated through the corresponding field. In this case, the RX-UE may preferentially attempt PSCCH reception based on the configuration of a specific PSCCH monitoring resource region having a higher priority in the overlapping resource region, based on the priority for each PSCCH monitoring resource region transmitted via the previous SCI.

Method #2: The priority for PSCCH monitoring may be performed based on the (L1) priority indicated in the 1st SCI. That is, the RX-UE may preferentially attempt PSCCH reception based on the configuration of a specific PSCCH monitoring resource region having a higher priority value in the overlapping resource region, based on each priority transmitted via the previous SCI.

Method #3: The priority for PSCCH monitoring may be determined based on the PC5 QoS (Quality of Service) Identifier (PQI) indicated from a higher layer. Therefore, it is possible to preferentially attempt PSCCH reception based on the configuration of a specific PSCCH monitoring resource region having a higher priority based on the PQI.

Method #4: The priority for PSCCH monitoring in Method #1 may be indicated and operated through PC5 RRC or MAC-CE instead of SCI. Since the RX-UE is in a situation of performing unicast communication with a plurality of TX-UEs, it is possible to operate to indicate the priority for PSCCH monitoring through a MAC-CE corresponding to a downlink shared channel (DL-SCH).

Method #5: The priority for PSCCH monitoring may be determined based on whether it is a retransmission. That is, if there is a retransmission PSCCH and PSSCH after transmitting a negative acknowledgment (NACK) for data transmitted through the previous PSCCH and PSSCH, the RX-UE may give priority to the corresponding PSCCH monitoring resource region configuration and preferentially attempt PSCCH reception based on the corresponding configuration value.

The above Method #1 to Method #5 may be applied and used in a simply modified, extended, or combined form.

### Fourth Disclosure: Reconfiguration of PSCCH Monitoring Resource Region

A TX-UE may reconfigure the PSCCH monitoring resource region when an acknowledgment (ACK) or NACK is not received from the RX-UE by a specific time after PSCCH and PSSCH transmission. At this time, the specific time may be a time value considering the maximum delay, latency, etc., for hybrid automatic repeat request (HARQ) feedback. The configuration for this value may be configured and operated through PC5 RRC, MAC-CE, or SCI. Alternatively, it may be configured and operated through a partial or full combination of PC5 RRC, MAC-CE, and SCI.

In the above method, the specific time after PSCCH and PSSCH transmission may be applied and operated with a value configured as the SL HARQ feedback timing.

In the above method, the time representation for the specific time after PSCCH and PSSCH transmission may be configured as up to a plurality of slots based on the slot in which the corresponding PSCCH and PSSCH were transmitted.

In the above method, the TX-UE may reconfigure the PSCCH monitoring resource region when the absence of an ACK or NACK from the RX-UE occurs N times by a specific time after PSCCH and PSSCH transmission. The N value may be configured and operated through PC5 RRC, MAC-CE, or SCI. Alternatively, it may be configured and operated through a partial or full combination of PC5 RRC, MAC-CE, and SCI.

In the above method, a time interval for counting N times when the absence of an ACK or NACK from the RX-UE occurs N times may be configured and operated with a specific value.

In the above method, N times when the absence of an ACK or NACK from the RX-UE occurs may be limited to consecutive cases for operation.

As described above, all content proposed in the present specification may be applied and operated in a simple, modified, or extended form in an SL communication environment.

Furthermore, although the present specification is described based on a 5G NR system, all cases where the concepts disclosed in the present specification are applicable, regardless of the specific wireless communication technology, may be included within the scope of the present specification.

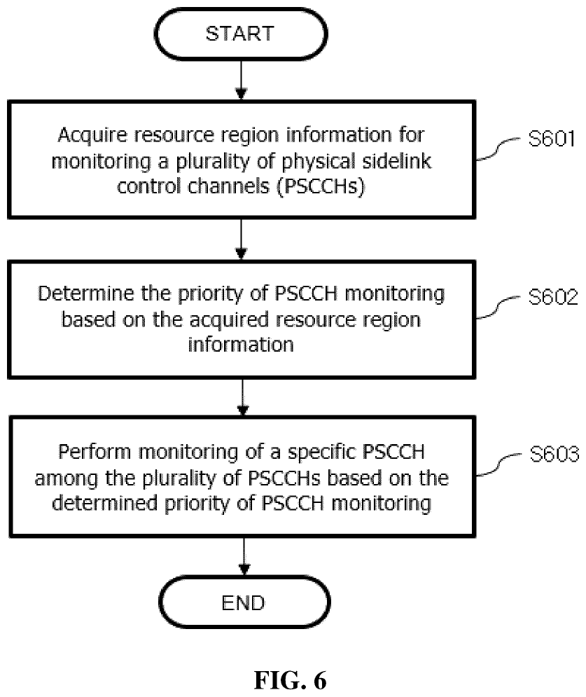

### FIG. 6 Illustrates an Operation Method of a Terminal According to an Embodiment of the Present Specification

Referring to FIG. 6, a receiving UE acquires resource region information for monitoring a plurality of Physical Sidelink Control Channels (PSCCHs) (S601). Thereafter, the receiving UE determines a priority for PSCCH monitoring based on the acquired resource region information (S602). Then, the receiving UE performs monitoring of a specific PSCCH among the plurality of PSCCHs based on the determined priority for PSCCH monitoring (S603).

The resource region information may be information in which all or part of the resource regions configured by a plurality of transmitting UEs overlap.

The determination of the priority for PSCCH monitoring may be based on a specific field of Sidelink Control Information (SCI). Here, the SCI may be a first-stage SCI, and the specific field may be a priority field.

The determination of the priority for PSCCH monitoring may be based on a PC5 QoS (Quality of Service) Identifier (PQI) indicated from a higher layer.

The determination of the priority for PSCCH monitoring may be based on signaling of PC5-RRC (Radio Resource Control) and/or a Medium Access Control-Control Element (MAC-CE).

The determination of the priority for PSCCH monitoring may be based on a retransmission status of a PSCCH and/or a Physical Sidelink Shared Channel (PSSCH).

Hereinafter, an apparatus to which the present specification may be applied will be described.

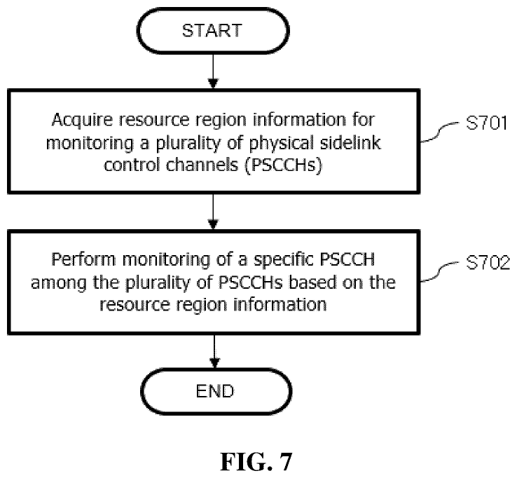

### FIG. 7 Illustrates an Operation Method of a Terminal According to Another Embodiment of the Present Specification

Referring to FIG. 7, a receiving UE acquires resource region information for monitoring a plurality of Physical Sidelink Control Channels (PSCCHs) (S701). Thereafter, based on the acquired resource region information, the receiving UE performs monitoring of a specific PSCCH among the plurality of PSCCHs (S702). Here, the resource region information is configured for transmissions from a plurality of transmitting UEs.

The resource region information may be associated with a specific Transmission Configuration Indicator (TCI) state.

The performing of the monitoring of the specific PSCCH among the plurality of PSCCHs may be based on a priority.

The priority may be indicated via a specific field of the Sidelink Control Information (SCI). As an example, the SCI may be a first-stage SCI, and the specific field may be a priority field.

Furthermore, the priority may be based on a PC5 QoS (Quality of Service) Identifier (PQI) indicated from a higher layer. Alternatively, the priority may be based on at least one of PC5-RRC (Radio Resource Control) signaling and Medium Access Control-Control Element (MAC-CE) signaling. Alternatively, the priority may be based on a retransmission status of at least one of a PSCCH and a Physical Sidelink Shared Channel (PSSCH).

At least one of the resource regions configured by the plurality of transmitting UEs may be reconfigured when an absence of Hybrid Automatic Repeat Request (HARQ) feedback from the receiving UE occurs N times, where Nis a natural number greater than or equal to 1.

Hereinafter, an apparatus to which the present specification may be applied will be described.

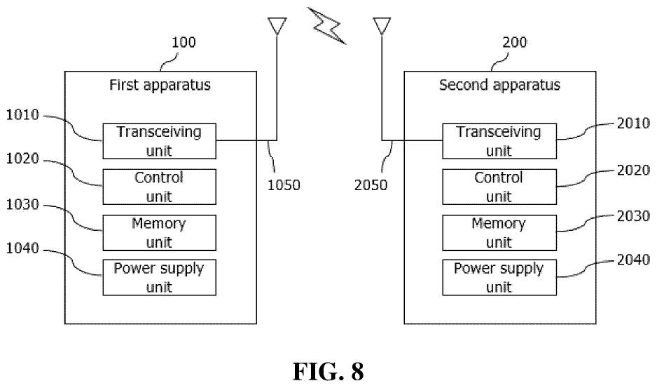

### FIG. 8 Illustrates a Wireless Communication Apparatus According to an Embodiment of the Present Specification

Referring to FIG. 8, a wireless communication system may include a first apparatus (100) and a second apparatus (200).

The first apparatus (100) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The second apparatus (200) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The first apparatus (100) may include at least one processor such as a control unit (1020), at least one memory such as a memory unit (1030), and at least one transceiver such as a transceiver unit (1010). It may further include a power supply unit (1040) for supplying and controlling power to the control unit (1020), the memory unit (1030), and/or the transceiver unit (1010). The control unit (1020) may perform the functions, procedures, and/or methods described above. The control unit (1020) may execute one or more protocols. For example, the control unit (1020) may execute one or more layers of a wireless interface protocol. The memory unit (1030) is connected to the control unit (1020) and may store various types of information and/or instructions. The transceiver unit (1010) is connected to the control unit (1020) and may be controlled to transmit and receive wireless signals.

The second apparatus (200) may include at least one processor such as a control unit (2020), at least one memory such as a memory unit (2030), and at least one transceiver such as a transceiver unit (2010). It may further include a power supply unit (2040) for supplying and controlling power to the control unit (2020), the memory unit (2030), and/or the transceiver unit (2010). The control unit (2020) may perform the functions, procedures, and/or methods described above. The control unit (2020) may execute one or more protocols. For example, the control unit (2020) may execute one or more layers of a wireless interface protocol. The memory unit (2030) is connected to the control unit (2020) and may store various types of information and/or instructions. The transceiver unit (2010) is connected to the control unit (2020) and may be controlled to transmit and receive wireless signals.

The memory unit (1030) and/or the memory unit (2030) may be connected internally or externally to the control unit (1020) and/or the control unit (2020), respectively, and may also be connected to other control units through various technologies such as wired or wireless connections.

The first apparatus (100) and/or the second apparatus (200) may have one or more antennas. For example, the antenna (1050) and/or the antenna (2050) may be configured to transmit and receive wireless signals.

While preferred embodiments have been exemplarily described above, the disclosure of this specification is not limited to these specific embodiments, and thus may be modified, changed, or improved in various forms within the spirit of this specification and the scope described in the claims.

What is claimed is:

1. A method of a receiving terminal for performing sidelink communication, the method comprising:
acquiring resource region information for monitoring a plurality of physical sidelink control channels (PSCCHs); and
performing monitoring of a specific PSCCH among the plurality of PSCCHs based on the resource region information,
wherein the resource region information is configured for transmissions from a plurality of transmitting terminals.

2. The method of claim 1, wherein the resource region information is associated with a specific transmission configuration indicator (TCI) state.

3. The method of claim 1, wherein the performing of the monitoring of the specific PSCCH among the plurality of PSCCHs is based on a priority.

4. The method of claim 3, wherein the priority is indicated via a specific field of sidelink control information (SCI).

5. The method of claim 4, wherein the SCI is a first-stage SCI, and the specific field is a priority field.

6. The method of claim 3, wherein the priority is based on a PC5 QoS (Quality of Service) identifier (PQI) indicated from a higher layer.

7. The method of claim 3, wherein the priority is based on a PC5-radio resource control (RRC) signaling or a medium access control-control element (MAC-CE) signaling.

8. The method of claim 3, wherein the priority is based on a retransmission status of a PSCCH or a physical sidelink shared channel (PSSCH).

9. The method of claim 1, wherein at least one of resource regions configured by the plurality of transmitting terminals is reconfigured when an absence of hybrid automatic repeat request (HARQ) feedback from the receiving terminal occurs N times, where Nis a natural number greater than or equal to 1.

10. A receiving terminal for performing sidelink communication, comprising:
a control unit; and
a memory unit to store instructions and operably and electrically connected with the control unit, wherein the instructions, when executed by the control unit, are configured to perform operations comprising:
acquiring resource region information for monitoring a plurality of physical sidelink control channels (PSCCHs); and
performing monitoring of a specific PSCCH among the plurality of PSCCHs based on the resource region information,
wherein the resource region information is configured for transmissions from a plurality of transmitting terminals.

11. The receiving terminal of claim 10, wherein the resource region information is associated with a specific transmission configuration indicator (TCI) state.

12. The receiving terminal of claim 10, wherein the performing of the monitoring of the specific PSCCH among the plurality of PSCCHs is based on a priority.

13. The receiving terminal of claim 12, wherein the priority is indicated via a specific field of sidelink control information (SCI).

14. The receiving terminal of claim 13, wherein the SCI is a first-stage SCI, and the specific field is a priority field.

15. The receiving terminal of claim 12, wherein the priority is based on a PC5 QoS (Quality of Service) identifier (PQI) indicated from a higher layer.

16. The receiving terminal of claim 12, wherein the priority is based on a PC5-radio resource control (RRC) signaling or a medium access control-control element (MAC-CE) signaling.

17. The receiving terminal of claim 12, wherein the priority is based on a retransmission status of a PSCCH or a physical sidelink shared channel (PSSCH).

18. The receiving terminal of claim 10, wherein at least one of resource regions configured by the plurality of transmitting terminals is reconfigured when an absence of hybrid automatic repeat request (HARQ) feedback from the receiving terminal occurs N times, where Nis a natural number greater than or equal to 1.
